(19) United States
(12) Patent Application Publication
(10) Pub. No.: US 2008/0023495 A1
(43) Pub. Date: Jan. 31, 2008

(54) VISCOUS LIQUID MATERIAL DISPENSING GUN

(75) Inventors: Takashi Takayama, Tama-Shi (JP); Ayako Murai, Yokohama-Shi (JP)

Correspondence Address: BURR & BROWN, PO BOX 7068, SYRACUSE, NY, 13261-7068, US

(73) Assignee: Q.P. Corporation, Shibuya-Ku (JP)

(21) Appl. No.: 11/782,908

(22) Filed: Jul. 25, 2007

(30) Foreign Application Priority Data
Jul. 28, 2006 (JP) 2006-206286

(51) Int. Cl. B67D 5/00; G01F 11/02

(52) U.S. Cl. 222/391

(57) ABSTRACT

A dispensing gun discharges a viscous liquid material through a plurality of discharge openings in equal amounts simultaneously. A dividing member divides a passage for the viscous liquid material into a first holding chamber and a second holding chamber and has a communicating opening preferably aligned with the axis of the passage. A flow of the viscous liquid material squeezed from a pouch and deviated from the axis of the passage is held temporarily in the first holding chamber and is forced through a communication opening into the second holding chamber along the axis of the passage. And the viscous liquid material held in the second holding chamber is distributed evenly to the discharge openings.

### BACKGROUND OF THE INVENTION

1. Field of the Invention

The present invention relates to a viscous liquid material dispensing gun for dispensing a viscous liquid material, such as mayonnaise, ketchup, and mustard, and, more specifically, to a technique for improving a viscous liquid dispensing gun such that equal quantities of a viscous liquid material are discharged through a plurality of discharge openings formed in an end disk.

2. Description of the Related Art

Various viscous liquid food materials, such as mayonnaise, ketchup and mustard, and pastes prepared by mixing chopped vegetables, such as onion and paprika, chopped boiled eggs and condiments are used prevalently in the kitchens of fast-food shops selling hamburgers or pizzas, and these viscous liquid food materials are contained in sealed containers. Food dispensing guns such as disclosed in Japanese Patent No. 2944116 are used for efficiently dispensing these viscous liquid food materials.

The food dispensing gun disclosed in the above mentioned Japanese patent document uses a container having a special shape as shown in FIGS. 1 and 2 attached to the specification thereof, which causes an economic problem.

A troublesome work need to be accomplished before using the container on a dispensing gun shown in FIG. 4 thereof to remove a cap screwed on the front end of the container, or to cut off a plug fitted in the front end part of the container, after storing the container in the dispensing gun. When the plug is cut off, fingertips, scissors or a cutter is likely to be smeared with the viscous liquid food material spilt from the container, this causes sanitary problem in the kitchens.

The inventors of the present invention developed a new dispensing gun as shown in FIGS. 23 and 24 attached to this specification and proposed the same dispensing gun in Japanese Patent Application 107929/2006.

This previously proposed dispensing gun has a gun body 1 having a holding unit 4 built by coaxially attaching an annular front and rear end members 3a, 3b to the front and rear end, respectively, of a curved shell 2 having a substantially semicircular cross section. A handle 5 attached to the rear end member 3a supports a rod 6 provided with a rack 6a coaxially with the rear end member 3a so as to be axially movable. A piston 7 is attached to the front end of the rod 6. A trigger 9 is pivotally supported on the handle 5 by a shaft 8. The trigger 9 engages with the rack 6a of the rod 6 and advances the rod 6 by a predetermined distance each time the trigger 9 is squeezed to push a pouch P containing a viscous liquid food material toward an extrusion opening. A cartridge 10 held in the holding unit 4 has a cylindrical body 11 having the shape of a circular cylinder, a fastening member 12 screwed on a front end part of the cylindrical body 11, a cutting blade 13 fastened to the open front end of the cylindrical body 11 with the fastening member 12, and a circular end disk 14 made of a film and provided with a plurality of discharge openings.

The trigger 9 is squeezed to advance the piston 7 after putting the pouch P in the cylindrical body 11. Then, the pouch P is advanced by the piston 7 and the front end part of the pouch P is pressed against the cutting blade 13, and consequently the front end part of the pouch P is cut open. Thus, an outlet through which the viscous liquid food material is pushed put is formed automatically in the front end part of the pouch P. When the trigger 9 is squeezed again to advance the piston 7 further, the viscous liquid food material packaged in the pouch P is pushed out of the pouch P. Then, the viscous liquid food material flows through a passage S formed in a front end part of the cylindrical body 11 to the end disk 14 and flows outside through the plurality of discharge openings formed by some slits in the end disk 14.

This previously proposed dispensing gun can use a generally marketed, inexpensive, flat pouch as a container for containing the viscous liquid food material, which does not cause any economic problem. Since the dispensing gun is provided with a built-in cutting blade 13 for cutting an outlet in the front end part of the pouch P, any work for cutting the front end part of the pouch P is not necessary, and the viscous liquid food material will not be spilt and will not cause a sanitary problem.

When the pouch P is advanced by squeezing the trigger 9, the front end part of the pouch P is pressed against the cutting blade 13 and the outlet through which the viscous liquid food material is discharged is formed automatically in the front end part of the pouch P.

However, the outlet formed in the front end part of the pouch P with the cutting blade 13, in some cases, is dislocated toward one end of the cutting blade 13 due to the repetition of a pushing operation of the trigger 9 or the deformation of the pouch P. Then, the flow of the viscous liquid food material discharged through the outlet is caused to deviate radially outward as indicated by the large arrow A and the small arrow B in FIG. 24. Consequently, the viscous liquid food material is discharged in different amounts through the plurality of discharge openings as indicated by the large arrow C and a small arrow D in FIG. 24. Thus, in some cases, the viscous liquid food material cannot be discharged through the plurality of discharge openings in equal amounts simultaneously.

### SUMMARY OF THE INVENTION

Accordingly, it is an object of the present invention to provide a dispensing gun capable of discharging a viscous liquid material in equal amounts simultaneously through a plurality of discharge openings.

A dispensing gun, in one aspect of the present invention, for dispensing a viscous liquid material through a plurality of discharge openings in equal amounts simultaneously includes: a cylindrical holding unit for holding a pouch containing the viscous liquid material; a piston for pushing the pouch held in the holding unit toward the discharge openings; an advancing means for advancing the piston by a predetermined distance at a time toward the discharge openings; a cutting means for cutting a front end part of the pouch to form an outlet through which the viscous liquid material is pushed out when the front end part is pressed against the cutting means; a closing member for closing a front end of a passage through which the viscous liquid material pushed out from the pouch flows and provided with the plurality of discharge openings; and a dividing member for dividing the passage between the cutting means and the closing member into a first holding chamber on the side of the cutting means and a second holding chamber on the side of the closing member, and provided with a communication opening aligned with the axis of the passage for communicating the first and the second holding chamber.

The dispensing gun of the present invention is built by additionally disposing the dividing member between the cutting means, namely, the cutting blade, and the closing member, namely, the end disk of the previously proposed dispensing gun.

The dividing member temporarily arrests the flow of the viscous liquid material pushed out through the outlet of the pouch to accumulate the viscous liquid material in the first holding chamber. Therefore, the direct flow of the viscous liquid material pushed out through the outlet of the pouch deviating from the axis of the passage to the closing member can be prevented.

When the pouch is pressed repeatedly by the piston to increase the pressure of the viscous liquid material held in the first holding chamber, the viscous liquid material is forced to flow from the first holding chamber through the communication opening into the second holding chamber. Since the communication opening of the dividing member is aligned or substantially aligned with the axis of the passage of the viscous liquid material, the viscous liquid material flows into the second holding chamber along or substantially along the axis of the passage of the viscous liquid material and the flow of the viscous liquid material will not deviate from the axis of the passage.

A fixed amount of the viscous liquid material flows through the communication opening into the second holding chamber each time the piston is advanced by a predetermined distance.

When the pouch is pressed by the piston, and the pressure of the viscous liquid material filling up the second holding chamber is increased, the viscous liquid material is discharged in equal amount through the plurality of discharge openings simultaneously.

The dividing member may be a flat plate disposed perpendicularly to the axis of the passage of the viscous liquid material pushed out from the pouch.

The dividing member may have a protruding central part or a tapered part aligned with the axis of the passage depending on the shape of the cutting means.

The communication opening of the dividing member may be a single hole aligned with the axis of the passage, a group of holes distributed around the axis of the passage, or a grid.

The shape of the communication opening is not limited to a circle, but may be a quadrilateral or a triangle selectively determined so as to conform to the arrangement of the plurality of discharge openings in the closing member.

Preferably, the communication opening formed in the dividing member has a sectional area between 10% and 800% of the sectional area of the passage of the viscous liquid material. Because, the dividing member cannot properly control the flow of the viscous liquid material and it is difficult to hold the viscous liquid material in the first holding chamber if the sectional area of the communication opening exceeds 80% of the sectional area of the passage. And, a very high pressure needs to be applied to the piston to squeeze out the viscous liquid material from the pouch and the efficiency of work using the dispensing gun will be reduced if the sectional area of the communication opening is below 10% of the sectional area of the passage.

Preferably, the discharge openings of the closing member lie radially outside the circumference of the communication openings when viewed in discharging direction.

Preferably, the discharge openings lie at the same radial distances, respectively, from the axis of the passage when viewed in discharging direction.

As apparent from the foregoing description, the dispensing gun of the present invention can discharge the viscous liquid material through the plurality of discharge openings in equal amounts simultaneously.

### BRIEF DESCRIPTION OF THE DRAWINGS

FIG. 1 is a partly sectional side elevation of a dispensing gun in a first embodiment according to the present invention;

FIG. 2 is an exploded sectional view of an important part of the dispensing gun shown in FIG. 1;

FIG. 3 is an exploded perspective view of component members shown in FIG. 2;

FIG. 4 is an end view of the dispensing gun shown in FIG. 1 taken from the side of discharge openings;

FIG. 5 is a longitudinal sectional view of assistance in explaining the operation of the dispensing gun in the first embodiment;

FIG. 6 is a front view of a dividing member in a first modification;

FIG. 7 is a front view of dividing member in a second modification;

FIG. 8 is a longitudinal sectional view of a dispensing gun in a first modification of the dispensing gun in the first embodiment;

FIG. 9 is a longitudinal sectional view of a dispensing gun in a second modification of the dispensing gun in the first embodiment;

FIG. 10 is a longitudinal sectional view of a dispensing gun in a third modification of the dispensing gun in the first embodiment;

FIG. 11 is a longitudinal sectional view of a dispensing gun in a fourth modification of the dispensing gun in the first embodiment;

FIG. 12 is a longitudinal sectional view of a dispensing gun in a fifth modification of the dispensing gun in the first embodiment;

FIG. 13 is a perspective view of a cutting blade in a first modification;

FIG. 14 is a perspective view of a cutting blade in a second modification;

FIG. 15 is a perspective view of a cutting blade in a third modification;

FIG. 16 is a perspective view of a cutting blade in a fourth modification;

FIG. 17 is a perspective view of a cutting blade in a fifth modification;

FIG. 18 is a longitudinal sectional view of assistance in explaining the operation of a dispensing gun in a second embodiment according to the present invention;

FIG. 19 is a longitudinal sectional view of assistance in explaining the operation of a dispensing gun in a third embodiment according to the present invention;

FIG. 20 is a longitudinal sectional view of a dispensing gun in a modification of the dispensing gun in the third embodiment;

FIG. 21 is a plan view of a pouch that can be used on a dispensing gun according to the present invention;

FIG. 22 is a fragmentary perspective view of assistance in explaining problems in a conventional pouch;

FIG. 23 is a partly sectional side elevation of a dispensing gun proposed in a patent application previously made by the inventors of the present invention; and

FIG. 24 is a longitudinal sectional view of assistance in explaining the operation of the dispensing gun shown in FIG. 23.

### DESCRIPTION OF THE PREFERRED EMBODIMENTS

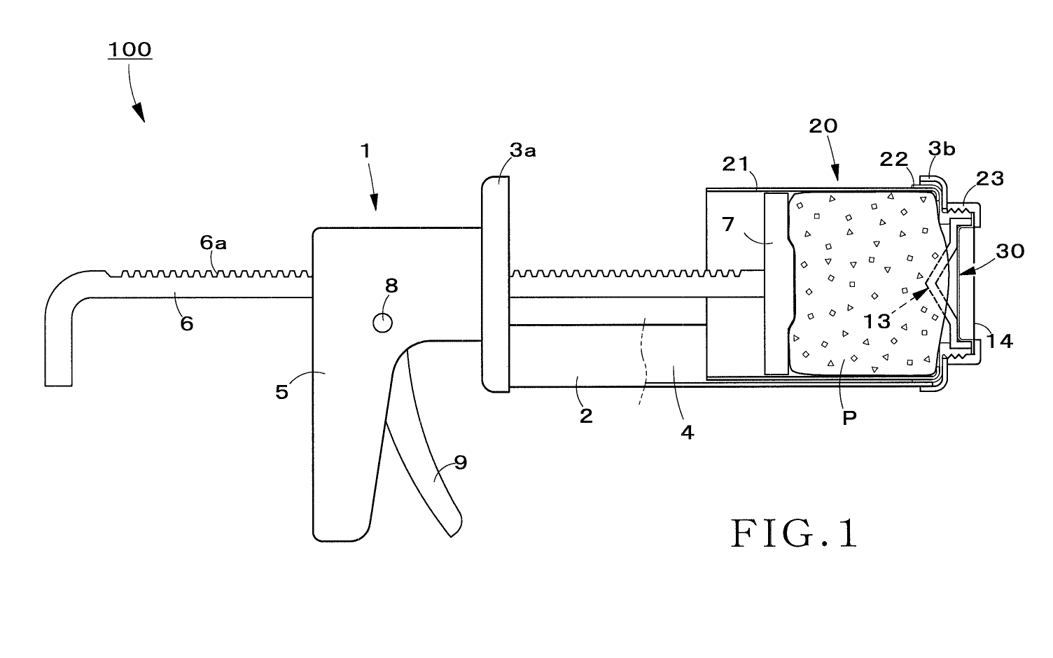

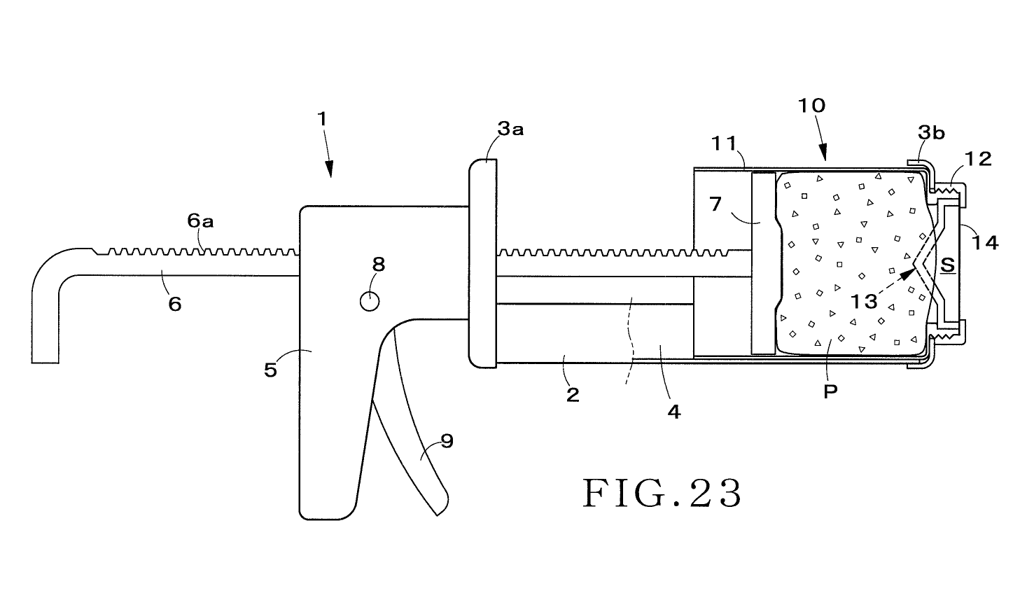

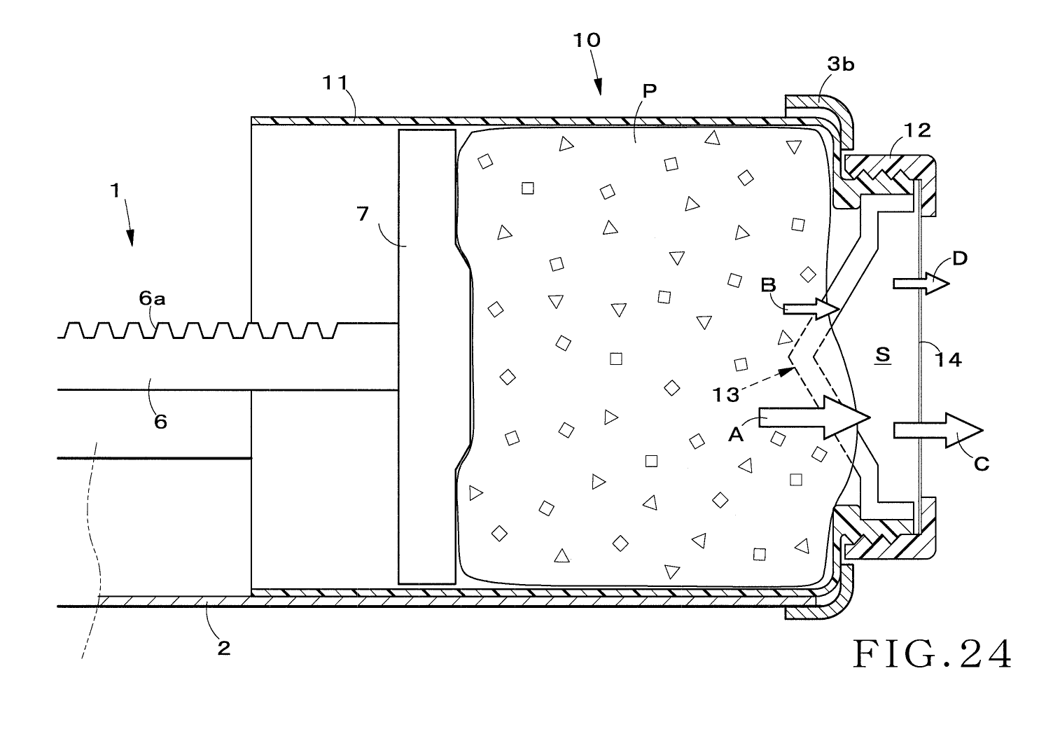

Dispensing guns in preferred embodiments according to the present invention for dispensing a viscous liquid food material will be described with reference to FIGS. 1 to 22. Parts shown in FIGS. 1 to 22 like or corresponding to those of the foregoing conventional dispensing gun shown in FIGS. 23 to 24 are designated by the same reference characters and the description thereof will be omitted. And, in the following description, a direction in which the viscous liquid material is discharged is specified as a forward direction.

### First Embodiment

A dispensing gun 100 in a first embodiment according to the present invention will be described with reference to FIGS. 1 to 5.

Referring to FIG. 1, the dispensing gun 100 has a holding unit 1, which is the same as the previously described holding unit shown in FIG. 23.

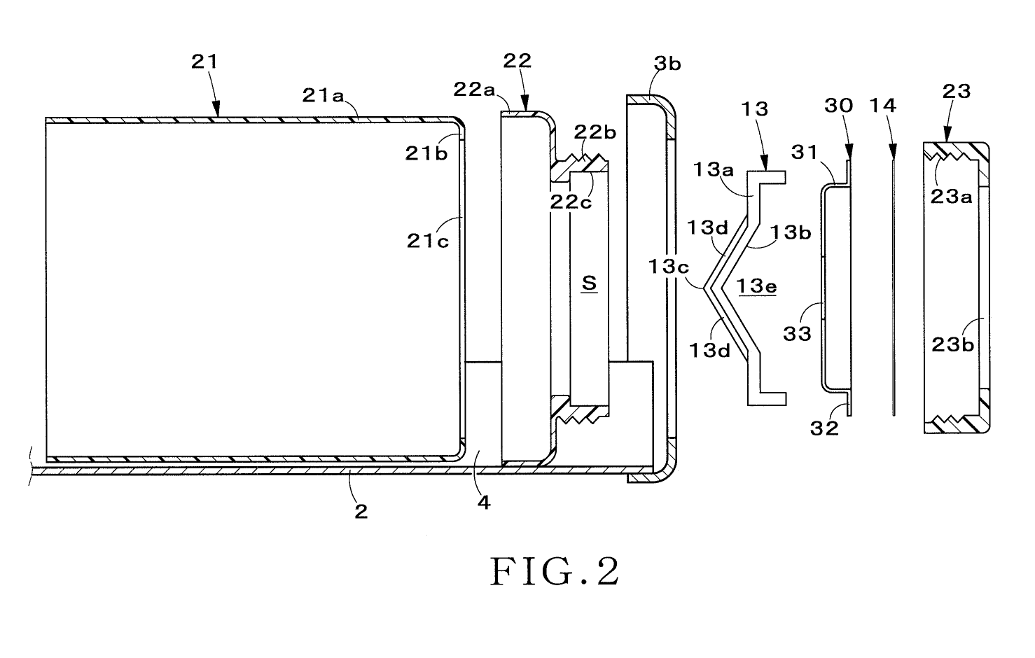

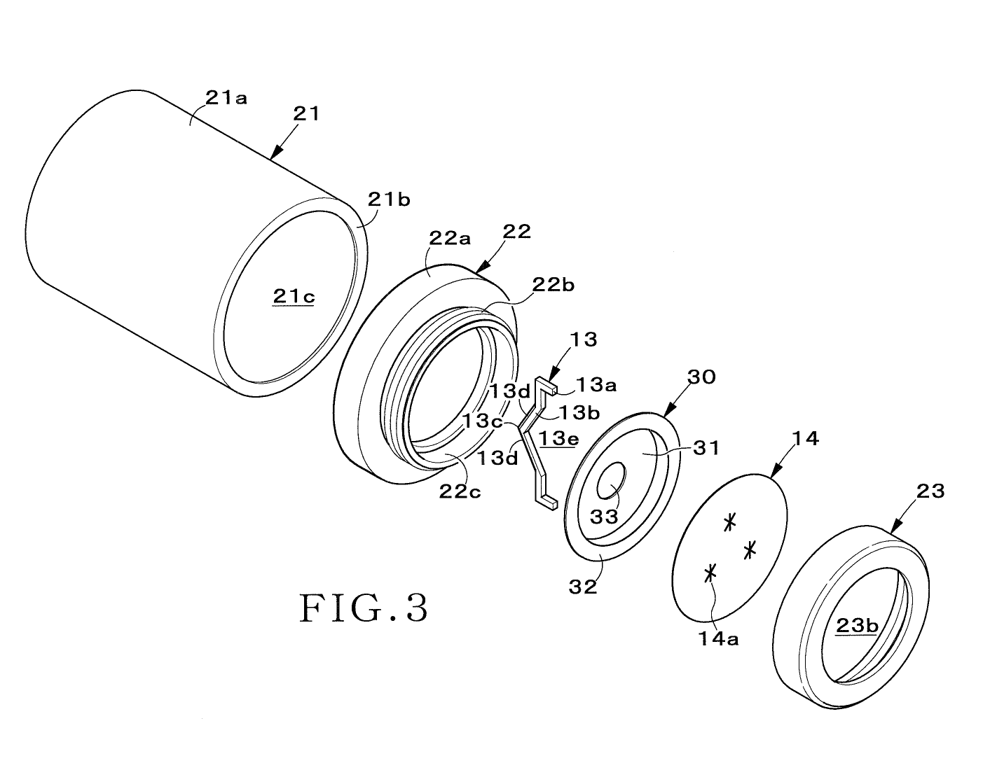

A cartridge 20 for holding a pouch P is different from the cartridge 10 shown in FIG. 24. The cartridge 20 is built by putting an annular member 22 on a front end part of a cylindrical member 21 having the shape of a circular cylinder. The cylindrical member 21 and the annular member 22 are separate members as shown in FIGS. 2 and 3. The cylindrical member 21 has a cylindrical body 21a and an inner flange 21b formed on the front end of the cylindrical body 21a. The flange 21b defines an opening 21c. The annular member 22 has a cylindrical part 22a put on the front end part of the cylindrical member 21, an externally threaded boss 22b protruding forward from the cylindrical part 22a, and a holding part 22c formed in the inner circumference of the externally threaded boss 22b. The holding part 22c defines a passage S for the viscous liquid food material to flow.

A cutting blade 13 has L-shaped end parts 13a on both sides, and a cutting part 13b having the shape of a chevron and protruding backward toward the pouch P. The cutting part 13b resembles a boomerang. The cutting part 13b has a sharp point 13c protruding backward toward the pouch P, and cutting edges 13d extending toward the end parts 13a from the point 13c and facing the pouch P. Front side surfaces of the cutting part 13b define a triangular void (space) 13e disposed adjacent to the passage S. The cutting blade 13 may be made of a metal, such as a stainless steel, or a resin, such as a hard polyethylene resin (PE) or a polyethylene terephthalate resin (PET).

A dividing member 30 has a main body 31 having the shape of a bottomed cylinder, and a flange 32 formed on the front end of the body 31. A communication opening 33 is formed coaxially with the main body 31 in the circular bottom wall of the main body 31. The dividing member 30 may be made of a metal, such as a stainless steel, or a resin, such as a hard polyethylene resin (PE) or a polyethylene terephthalate resin (PET).

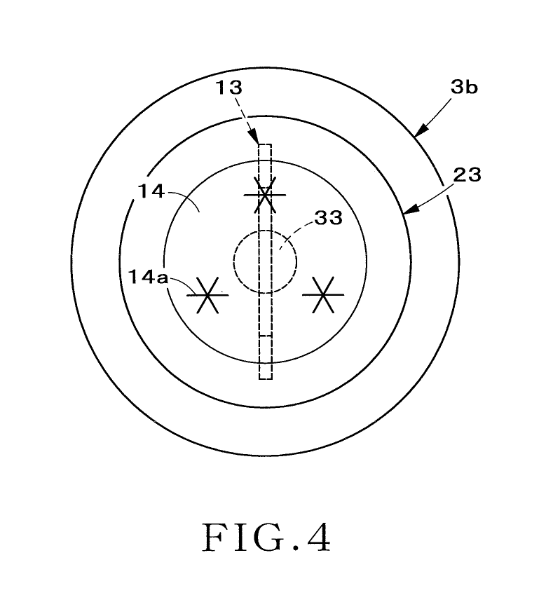

A closing member 14 is a thin disk of a resin, such as a polyethylene resin or a polyamide resin. The closing member 14 is provided with three discharge openings 14a. Each of the discharge openings 14a is a combination of slits. As shown in FIG. 4, the discharge openings 14a lie radially outward the circumference of the communication opening 33, and the discharge openings 14a are disposed at the same radial distances, respectively, from the axis of the passage S.

The externally threaded boss 22b of the annular member 22 is inserted in an opening formed in the front end part 3b of a gun body 1. Then, the cutting blade 13, the dividing member 30 and the closing member 14 are fitted in the holding part 22c of the annular member 22. Then, an internally threaded part 23a of a fastening member 23 is screwed on the externally threaded part 22b to fasten the cutting blade 13, the dividing member 30 and the closing member 14 to the gun body 1.

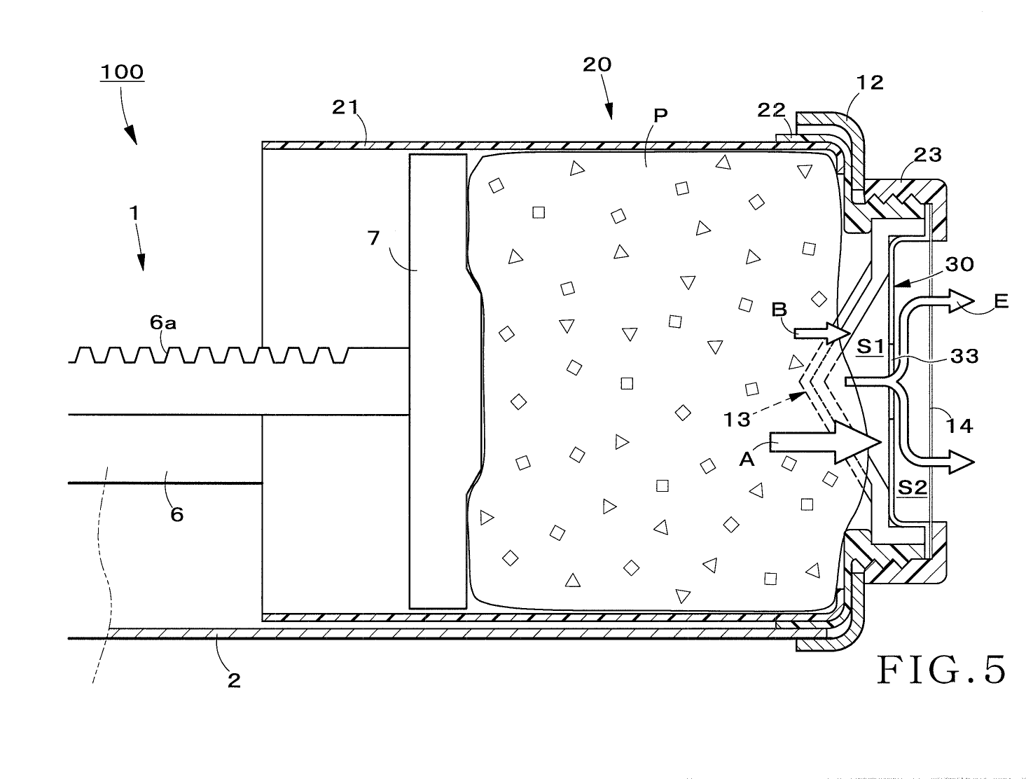

When the cutting blade 13, the dividing member 30 and the closing member 14 are thus fastened to the gun body 1, the passage S defined by the externally threaded part 22b is divided into a first holding chamber S1 and a second holding chamber S2. The first holding chamber is behind the dividing member 30, i.e., on the side of the cutting blade 13, and the second holding chamber S2 is in front of the dividing member 30, i.e., on the side of the closing member 14 as shown in FIG. 5.

Since the cylindrical member 21 and the annular member 22 are separate members, a new pouch P filled up with the viscous liquid food material can be put on the gun body 1 by the steps of putting the pouch P on the cylindrical member 21, fitting the cylindrical member 21 in a concave holding part 4 of the gun body 1, and fitting a front end part of the cylindrical member 21 in the cylindrical part 22a of the annular member 22. Air remaining in spaces defined between the cylindrical member 21 and the annular member 22 escapes through a gap between the front end of the cylindrical member 21 and the annular member 22. Therefore, the viscous liquid food material remaining in the annular member 22 and the fastening member 23 will not be accidentally pushed forward by the pressure of air. Thus the viscous liquid food material will not accidentally leak from the dispensing gun 100.

After the viscous liquid food material contained in the pouch P has been exhausted, the empty pouch P and the cylindrical member 21 are separated together from the cylindrical part 22a of the annular member 22, and the empty pouch P can be easily removed from the cylindrical member 21. The inner circumference of the cylindrical member 21 is difficult for the viscous liquid food material to adhere and the inner circumference of the cylindrical member 21 can be easily cleaned even if the viscous liquid food material adheres thereto. Thus the dispensing gun 100 ensures sanitary work.

After the new pouch P has been loaded into the dispensing gun 100, a trigger 9 supported on the gun body 1 is squeezed to advance a piston 7. The piston 7 pushes the pouch P forward to press the front end part of the pouch P against the cutting edges 13d of the cutting blade 13. Thus an outlet trough which the viscous liquid food material is pushed out is formed in the front end part of the pouch P.

As shown in an enlarged view in FIG. 5, the sharp point 13c protruding backward toward the pouch P pierces the pouch P, and the circumference of the outlet of the pouch P lies around the void (space) 13e extending in front of the cutting part 13b. Therefore, the outlet through which the viscous liquid food material is pushed out will not close. Thus the viscous liquid food material contained in the pouch P can be surely pushed out of the pouch P.

In some cases, the outlet formed in the front end part of the pouch P is shifted toward one side of the cutting blade 13 when the pouch P is pressed repeatedly by the piston 7 and the pouch P is deformed. If the outlet is shifted, the flow of the viscous liquid food material pushed out through the outlet is caused to deviate radially outward as indicated by the large arrow A and the small arrow B in FIG. 5. However, the flow of the viscous liquid food material pushed out of the pouch P through the outlet is dammed temporarily by the dividing member 30 and is held temporarily in the first holding chamber S1. Thus the deviated flow of the viscous liquid food material is prevented from directly reaching the closing member 14.

When the pouch P is pressed repeatedly by the piston 7 to increase the pressure of the viscous liquid food material in the first holding chamber S1, the viscous liquid food material flows gradually through the communication opening 33 of the dividing member 30 from the first holding chamber S1 into the second holding chamber S2. Since the communication opening 33 of the dividing member 30 is aligned with the axis of the passage S, the viscous liquid food material flows coaxially with the passage S into the second holding chamber S2 and the flow of the viscous liquid food material will not deviate from the axis of the passage S.

A fixed amount of the viscous liquid food material is caused to flow through the communication opening 33 into the second holding chamber S2 each time the piston 7 is advanced by a predetermined distance. Each time the pressure of the viscous liquid food material contained in the pouch P is raised by pressing the pouch P by the piston 7, the viscous liquid food material is discharged through the discharge openings 14a of the closing member 14 in equal amounts simultaneously as indicated by the arrows E in FIG. 5.

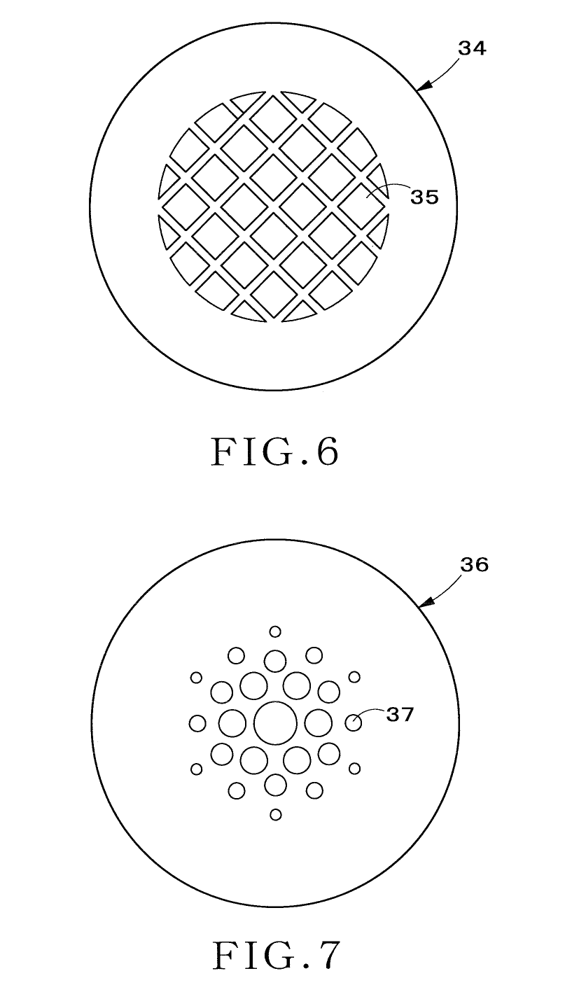

The dividing member 30 of the dispensing gun 100 in the first embodiment is provided with the single communication opening 33 aligned with the passage S of the viscous liquid food material. The dispensing gun 100 may be provided with a dividing member 34 provided with an communication opening 35 having the shape of a grid as shown in FIG. 6 or a dividing member 36 having a communication opening 37 including a set of circular openings as shown in FIG. 7. The dimensions of the communication openings 35 and 37 shown in FIGS. 6 and 7 should be determined such that the deviated flow of the viscous liquid food material as indicated by the arrows A and B in FIG. 5 can be dammed temporarily and the viscous liquid food material is held temporarily in the first holding chamber S1.

Modification of Dispensing Gun

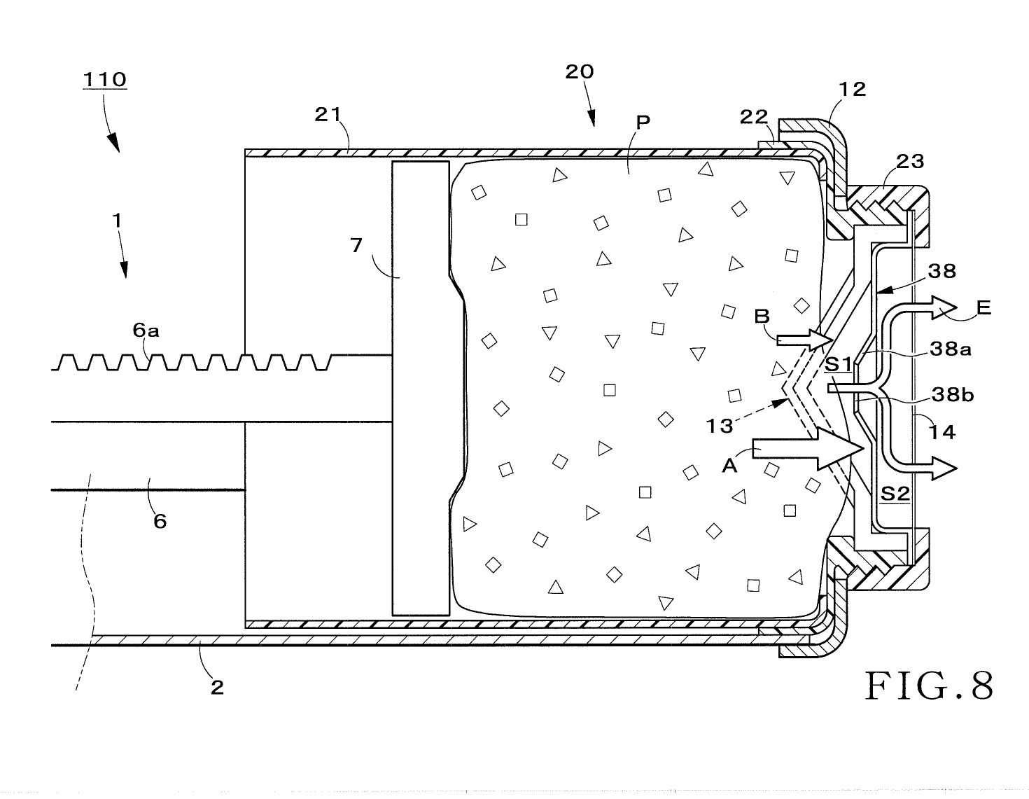

Modifications of the dispensing gun 100 in the first embodiment will be described with reference to FIGS. 8 to 12.

First Modification

A dispensing gun 110 in a first modification shown in FIG. 8 is provided with a dividing member 38 having a tapered central part 38a having the shape of a truncated circular cone protruding toward a cutting blade 13. The central part 38a has a bottom wall provided with a communication opening 38b. The dividing member 38 divides a passage S into a first holding chamber S1 and a second holding chamber S2. The first holding chamber is behind the dividing member 38, i.e., on the side of the cutting blade 13, and the second holding chamber S2 is in front of the dividing member 38, i.e., on the side of a closing member 14.

The deviated flow of the viscous liquid food material pushed out of a pouch P indicated by the arrows A and B is dammed temporarily by the dividing member 38, and is guided by the tapered surface of the central part 38a so as to reverse toward the pouch P, and then flows through the communication opening 38b into the second holding chamber S2. Thus the deviated flow of the viscous liquid food material can be surely guided toward the center of the central part 38a of the dividing member 38.

Second Modification

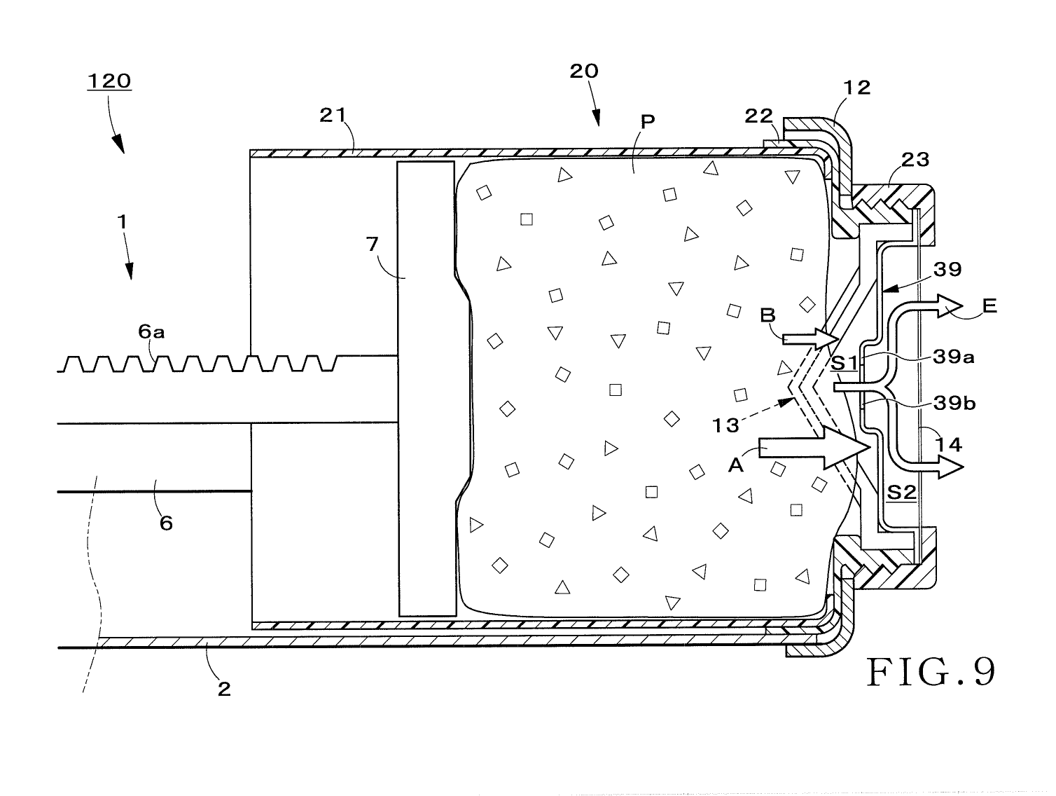

A dispensing gun 120 in a second modification shown in FIG. 9 is provided with a dividing member 39 having a cylindrical central part 39a having the shape of a bottomed cylinder protruding toward a cutting blade 13. The central part 39a has a bottom wall provided with a communication opening 39b. The dividing member 39 divides a passage S into a first holding chamber S1 and a second holding chamber S2. The first holding chamber is behind the dividing member 39, i.e., on the side of the cutting blade 13, and the second holding chamber S2 is in front of the dividing member 39, i.e., on the side of a closing member 14.

The deviated flow of the viscous liquid food material pushed out of a pouch P indicated by the arrows A and B is dammed temporarily by the dividing member 39, and is obstructed by the cylindrical side wall of the cylindrical central part 39a so as to reverse toward the pouch P, and then flows through the communication opening 39b into the second holding chamber S2. Thus the deviated flow of the viscous liquid food material can be surely guided toward the center of the central part 39a of the dividing member 39.

Third Modification

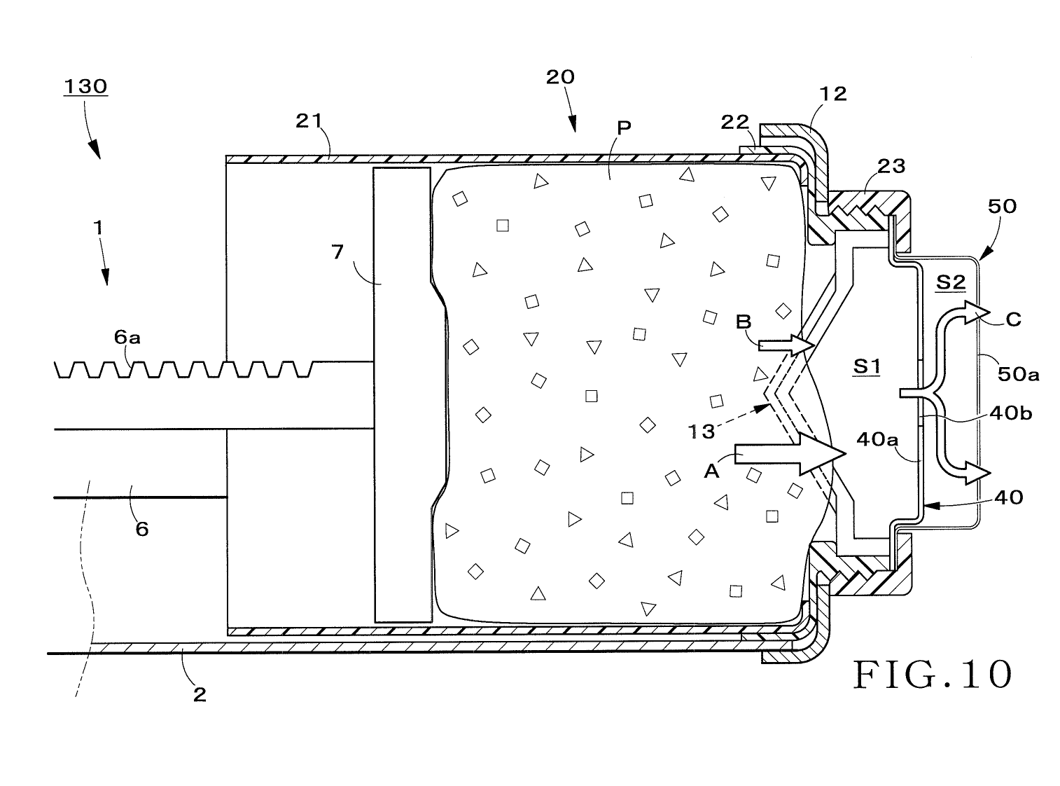

A dispensing gun 130 in a third modification shown in FIG. 10 is provided with a dividing member 40 having a cylindrical part having the shape of a bottomed cylinder protruding forward, i.e., a discharging direction. This part has a bottom wall 40a provided with a communication opening 40b.

The dispensing gun 130 is provided with a closing member 50 having a cylindrical part having a bottom wall 50a provided with three discharge openings.

The dividing member 40 divides a passage S into a first holding chamber S1 and a second holding chamber S2. The first holding chamber S1 is behind the dividing member 40, i.e., on the side of the cutting blade 13, and the second holding chamber S2 is in front of the dividing member 40, i.e., on the side of the closing member 50.

The first holding chamber S1 has a volume greater than those of the foregoing first holding chambers S1.

The deviated flow of the viscous liquid food material pushed out of a pouch P indicated by the arrows A and B is obstructed by the viscous liquid food material stored in the large first holding chamber S1 and hence cannot flow directly through the communication opening 40b into the second holding chamber S2.

Fourth Modification

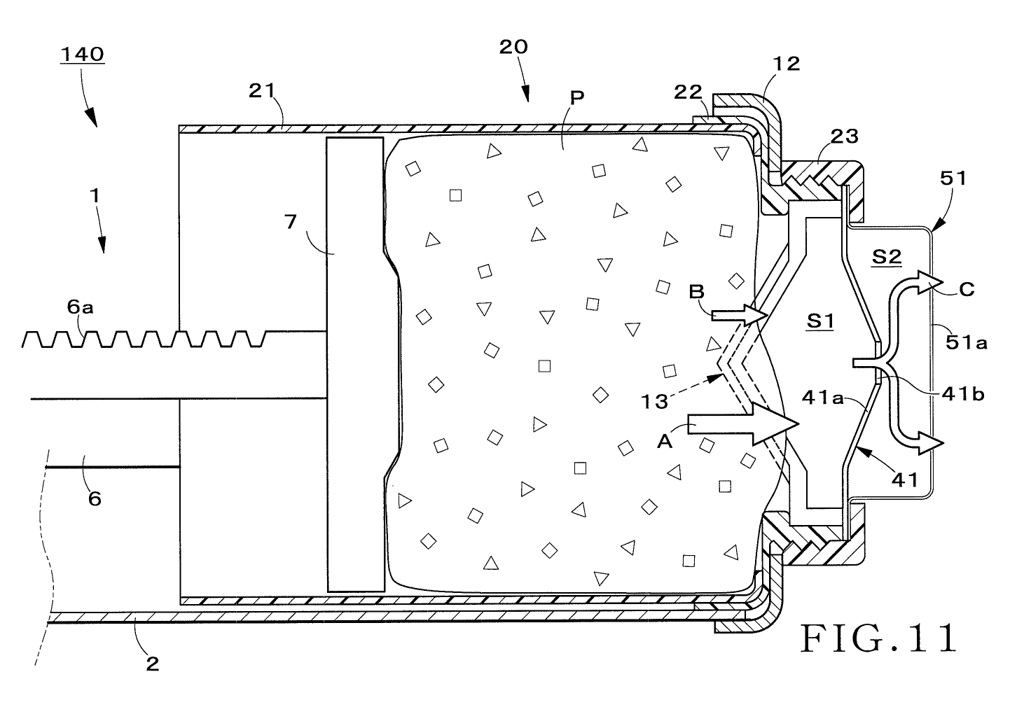

A dispensing gun 140 in a fourth modification shown in FIG. 11 is provided with a dividing member 41 having a large, tapered central part 41a having the shape of a truncated circular cone protruding in a discharging direction. The central part 41a has a front end wall provided with a communication opening 41b coaxial with the passage S.

The dispensing gun 140 is provided with a closing member 51 having a cylindrical part protruding in a discharging direction and having a bottom wall 51a provided with three discharge openings.

The dividing member 41 divides a passage S into a first holding chamber S1 and a second holding chamber S2. The first holding chamber S1 is behind the dividing member 41, i.e., on the side of the cutting blade 13, and the second holding chamber S2 is in front of the dividing member 41, i.e., on the side of the closing member 51. The first holding chamber S1 has a volume greater than those of the foregoing first holding chambers S1.

The deviated flow of the viscous liquid food material pushed out of a pouch P indicated by the arrows A and B is obstructed by a large amount of the viscous liquid food material stored in the large first holding chamber S1. The viscous liquid food material stored in the first holding chamber S1 is guided by the tapered central part 41a toward the communication opening 41b formed coaxially with the passage S in the front end wall of the tapered central part 41a. Thus the deviated flow of the viscous liquid food material cannot flow directly through the communication opening 41b into the second holding chamber S2.

Fifth Modification

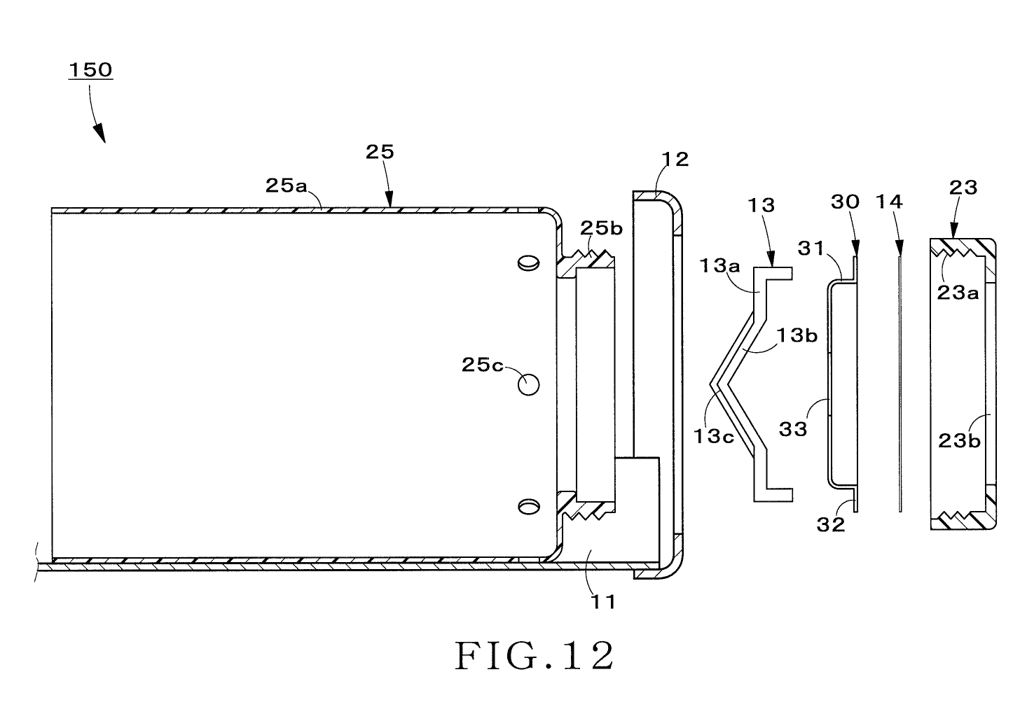

A dispensing gun 150 in a fifth modification will be described with reference to FIG. 12. In the dispensing gun 100 in the first embodiment, the cartridge 20 containing a pouch P and held in the holding unit 4 of the gun body 1 is built by putting the annular member 22 on the front end part of the cylindrical member 21 having the shape of a circular cylinder. The cylindrical member 21 and the annular member 22 are separate members.

On the contrary, the dispensing gun 150 in the fifth modification shown in FIG. 12 includes a cartridge 25 having a cylindrical body 25a and an externally threaded boss 25b. The cylindrical body 25a and the externally threaded boss 25b are integrally united. Preferably, a plurality of vent holes 25c are formed in a boundary part between the cylindrical body 25a and the externally threaded boss 25b. Air contained in the cartridge 25 flows out of the cartridge 25 through the vent holes 25b when a new pouch P fully filled with a viscous liquid food material is inserted into the cylindrical body 25a, so that the viscous liquid food material remaining around a dividing member 30 is not discharged by the pressure of the compressed air.

Modification of Cutting Blade

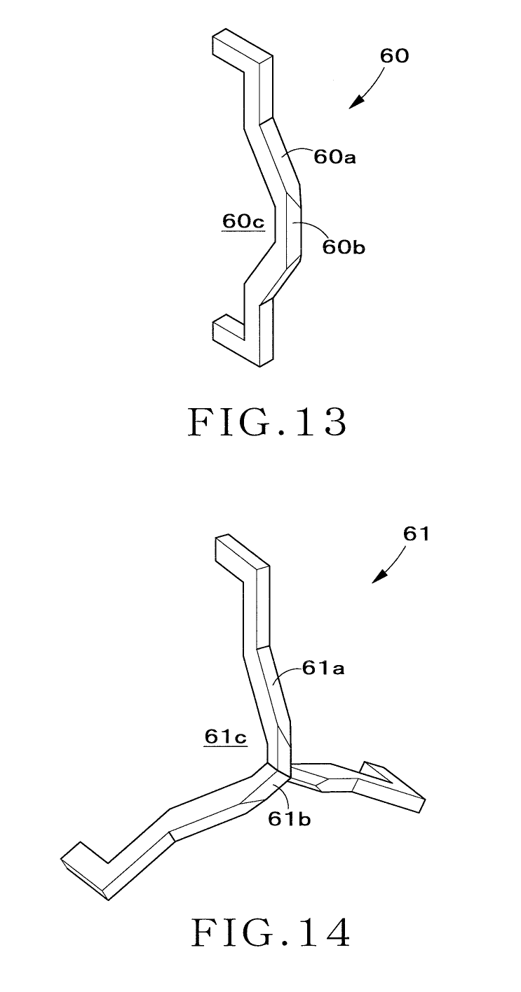

Cutting blades in modifications will be described with reference to FIGS. 13 to 17.

Each of the dispensing gun 100 in the first embodiment and the dispensing guns in the modifications of the dispensing gun 100 is provided with the cutting blade 13 having the shape of a boomerang. Dispensing guns according to the present invention may be provided with a cutting blade of any suitable shape, provided that the cutting blade can define a void (space) on the front side with respect to a discharging direction. When a void (space) extends on the front side of the cutting blade with respect to the discharging direction, the void (space) will not be entirely clogged up with a warped front end part of a pouch P pushed forward, and the viscous liquid food material pushed out of the pouch through an outlet formed in the front end part of the pouch P can flow through the void toward the discharge openings.

A cutting blade 60 shown in FIG. 13 has a cutting part 60a having the shape of a chevron and protruding backward with respect to the discharging direction. The cutting part 60a has a sharp, straight cutting edge 60b perpendicular to the axis of the passage S. A void (space) 60c is formed on the front side with respect to the discharging direction of the cutting edge 60b.

A cutting blade 61 shown in FIG. 14 has a trident cutting part 61a having three cutting edges 61b. A void (space) 61c is formed on the front side with respect to the discharging direction of the cutting edges 61b.

The cutting blades 60 and 61, similarly to the cutting blade 13, can form the void (space) in a central part of the passage S.

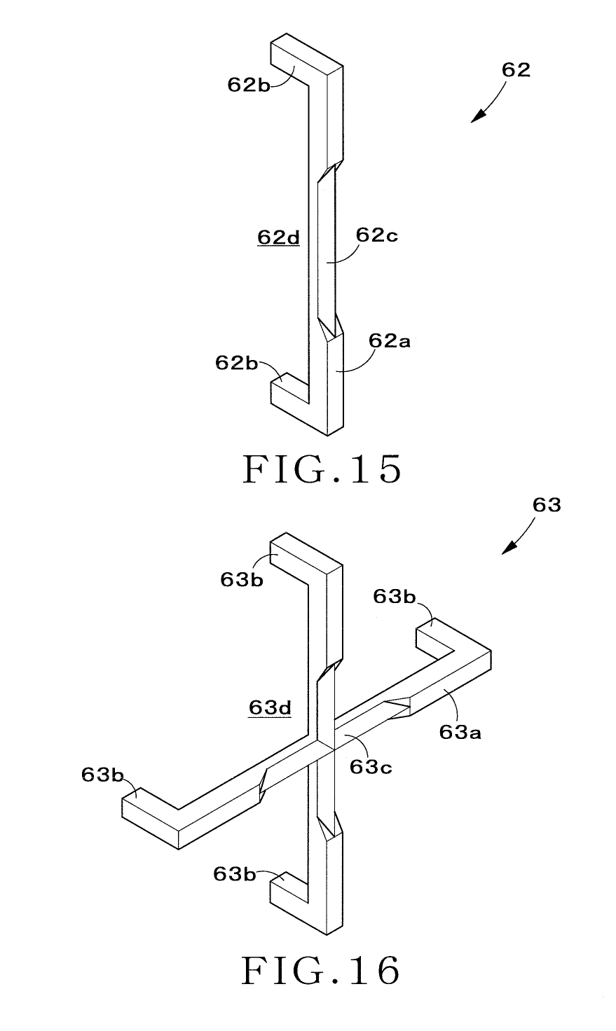

A cutting blade 62 shown in FIG. 15 has a straight cutting part 62a having a cutting edge 62c and extending perpendicular to the axis of the passage S, and opposite L-shaped end parts 62b. Thus the cutting blade 62 forms a void (space) 62d on the front side with respect to the discharging direction of the cutting edge 62c.

A cutting blade 63 shown in FIG. 16 has a cruciform cutting part 63a having four cutting edges 63c and extending perpendicular to the axis of the passage S, and four L-shaped end parts 63b. Thus a void (space) 63d is formed on the front side with respect to the discharging direction of the cutting edges 63c.

Each of the cutting blades 62 and 63 forms a void (space) extending along the diameter of the passage S.

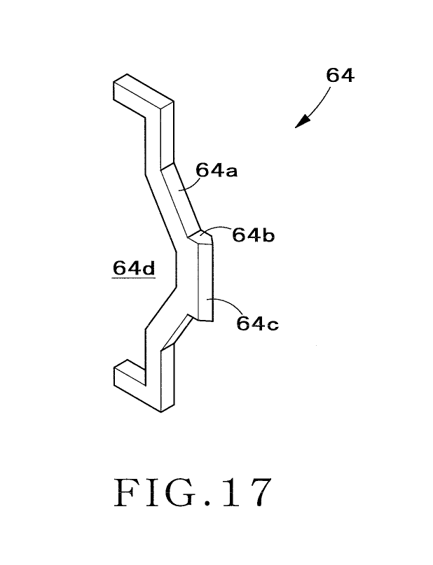

A cutting blade 64 shown in FIG. 17 has a shape designed by modifying that of the cutting blade 60 shown in FIG. 13. The cutting blade 64 has an cutting part 64a protruding in the shape of a chevron toward the pouch P. The cutting part 64a has opposite arms obliquely extending from the pouch P, and a straight connecting part 64b extending perpendicular to the axis of the passage S and connecting the free ends of the opposite arms. A cutting edge 64c extending perpendicular to the axis of the passage S is formed in the back side with respect to the discharging direction of the straight connecting part 64b. Thus, a void (space) 64d is formed on the front side with respect to the discharging direction of the cutting edge 64c.

However, particularly desirable shape of the cutting blade is a boomerang-shape, which is formed by cutting out a chevron-shaped blank from a flat plate, and processing the blank to form the cutting blade 13 having a sharp point 13c protruding backward toward the pouch P and cutting edges 13d extending in opposite directions from the point 13c.

Because, when the boomerang-shaped cutting blade 13 is used, the sharp point 13c of the cutting blade 13 pierces the front end part of the pouch P and forms an opening in the front part when the pouch P is advanced in the cylindrical member 21 and pressed against the cutting blade 13. The triangular void (space) 13e is formed on the front side with respect to the discharging direction of the sharp point 13c, the opening formed in the front end part of the pouch P can open into the passage S for the viscous liquid food material formed in the annular member 22.

Thus the triangular void (space) 13e will not be entirely clogged when the pouch P is pushed forward by the piston 7. And, the viscous liquid food material contained in the pouch P and pushed out through the outlet formed in the front end part of the pouch P can flow forward though the triangular void (space) 13e.

Also, the sharp point 13c of the boomerang-shaped cutting blade 13 remains stuck in the opening formed in the front end part of the pouch P, the opening of the pouch P will not be dislocated relative to the axis of the passage S for the viscous liquid food material even if the pouch P is twisted in the cylindrical member 21. Thus the viscous liquid food material can be pushed out of the pouch P.

### Second Embodiment

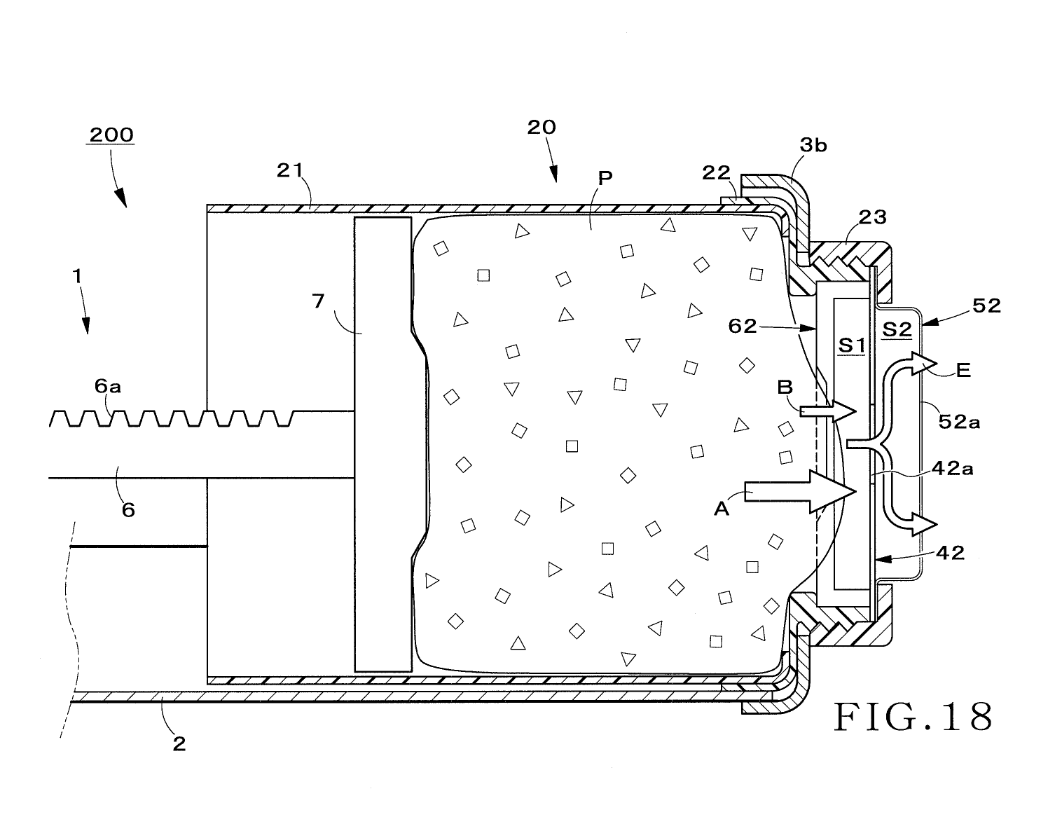

A dispensing gun 200 in a second embodiment according to the present invention will be described with reference to FIG. 18.

The dispensing gun 200 employs the cutting blade 62 shown in FIG. 15.

Therefore, a dividing member 42 is formed as a flat plate disposed perpendicularly to the axis of the passage S and provided in its central part with a communication opening 42a.

A closing member 52 has the shape of a bottomed cylinder protruding in the discharging direction and having a bottom wall 52a provided with three discharge openings.

A first holding chamber S1 is formed on the side of the cutting blade 62 with respect to the dividing member 42, and a second holding chamber S2 is formed on the side of the closing member 52. Thus the deviated flow of the viscous liquid food material indicated by the arrows A and B can be prevented from directly flowing to the closing member 52.

### Third Embodiment

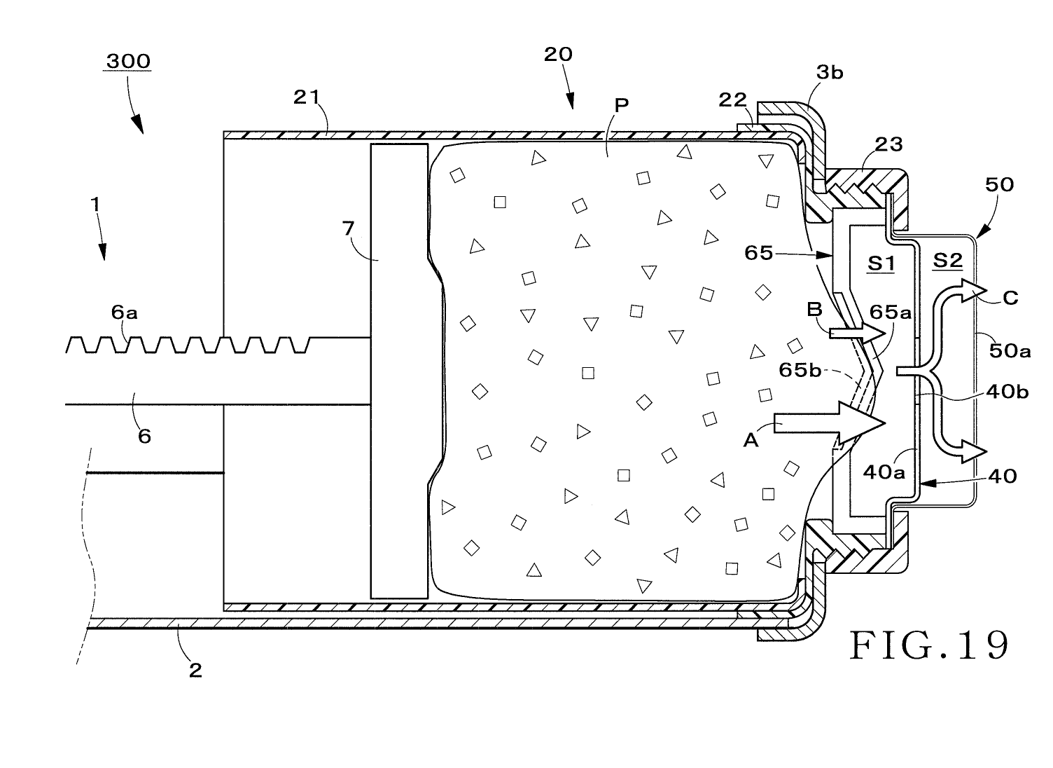

A dispensing gun 300 in a third embodiment according to the present invention will be described with reference to FIG. 19.

The dispensing gun 300 employs a cutting blade 65 having a chevron-shaped cutting part 65a protruding in the discharging direction. Two cutting edges 65b are formed in sides facing a pouch P, respectively, of the cutting part 65a. In the dispensing gun 300, voids (spaces) are formed on the back side of opposite end parts of the cutting blade 65, respectively.

Therefore, a dividing member 40 has the shape of a bottomed cylinder protruding toward a closing member 50 and having a bottom wall 40a provided with a communication opening 40b.

Also, the closing member 50 has the shape of a bottomed cylinder protruding in the discharging direction and having a bottom wall 50a provided with three discharge openings.

A first holding chamber S1 is formed on the side of the cutting blade 65 with respect to the dividing member 40, and a second holding chamber S2 is formed on the side of the closing member 50. Thus the deviated flow of the viscous liquid food material indicated by the arrows A and B can be prevented from directly flowing to the closing member 50.

### Fourth Embodiment

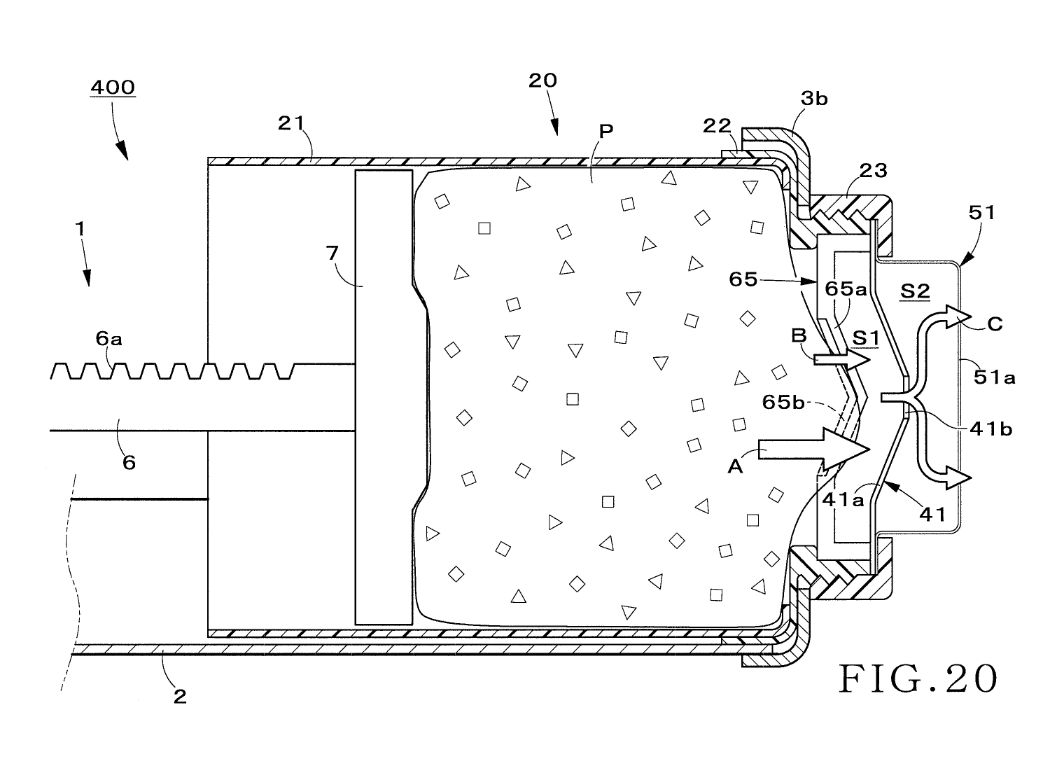

A dispensing gun 400 in a fourth embodiment according to the present invention will be described with reference to FIG. 20.

The dispensing gun 400 in the fourth embodiment employs a cutting blade 65 similar to that employed in the dispensing gun 300 in the third embodiment. The cutting blade 65 has a chevron-shaped cutting part 65a protruding in the discharging direction. Two cutting edges 65b are formed in sides facing a pouch P, respectively, of the cutting part 65a.

Therefore, a dividing member 41 has a tapered central part 41a protruding toward a closing member 51 and having a communication opening 41b provided at the end of the tapered central part 41a.

Also, the closing member 51 has the shape of a bottomed cylinder protruding in the discharging direction and having a bottom wall 51a provided with discharge openings.

A first holding chamber S1 is formed on the side of the cutting blade 65 with respect to the dividing member 41, and a second holding chamber S2 is formed on the side of the closing member 51.

The deviated flow of the viscous liquid food material indicated by the arrows A and B is guided by the tapered central part of the dividing member 41 toward the communication opening 41b formed in the bottom wall of the dividing member 41. Thus the deviated flow of the viscous liquid food material indicated by the arrows A and B can be prevented from directly flowing to the closing member 51.

Although the present invention has been described in terms of the dispensing guns in the preferred embodiment thereof, obviously many changes and variations are possible in the preferred embodiments and hence the present invention is not limited in its practical application to the preferred embodiments specifically described herein.

For example, although the closing member 14 included in the dispensing gun 100 in the first embodiment is provided with the three discharge openings 14a as shown in FIG. 4, the closing member 14 may be provided with more than three discharge openings.

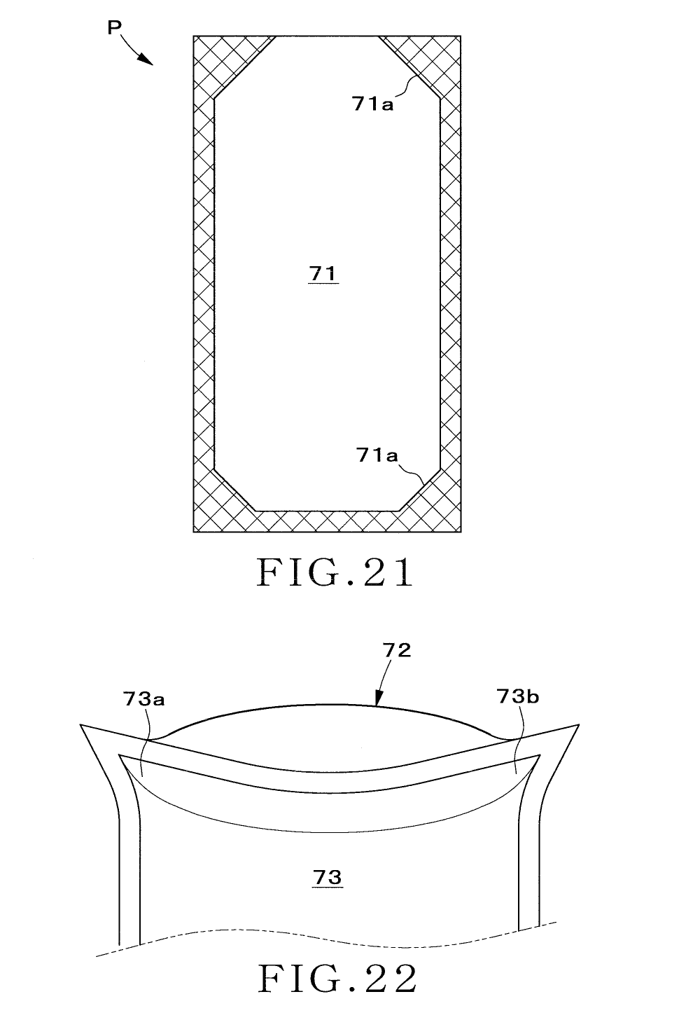

Preferably, the four inside corners 71a of a sealed part surrounding a main body 71 of a pouch P containing a viscous liquid food material are diagonal to the sealed part as shown in FIG. 21 instead of perpendicular to the sealed part. Because, if the inside corners of the sealed part are perpendicular to the sealed part, corner parts 73a and 73b of the pouch protrude in corners when a main body 73 of the pouch is gripped to insert the pouch into the cartridge 20 of the dispensing gun. The corner parts 73a and 73b thus protruding in corners make it difficult to insert the pouch P into the cylindrical member 21.

It goes without saying that the dispensing guns in the preferred embodiments of the present invention are applicable not only to dispensing viscous liquid food materials in the kitchens of fast-food shops and public restaurants, but also to dispensing viscous liquid materials other than viscous liquid food materials.

1. A dispensing gun for dispensing a viscous liquid material through a plurality of discharge openings in equal amounts simultaneously, said dispensing gun comprising:
a cylindrical holding unit for holding a pouch containing the viscous liquid material;
a piston for pushing the pouch held in the holding unit toward the discharge openings;
an advancing means for advancing the piston by a predetermined distance at a time toward the discharge openings;
a cutting means for cutting a front end part of the pouch to form an outlet through which the viscous liquid material is pushed out when the front end part is pressed against the cutting means by the piston;
a closing member for closing a front end of a passage through which the viscous liquid material pushed out from the pouch flows and provided with the plurality of discharge openings; and
a dividing member for dividing the passage between the cutting means and the closing member into a first holding chamber on the side of the cutting means and a second holding chamber on the side of the closing member, and provided with a communication opening for communicating the first and the second holding chamber.

2. The dispensing gun according to claim 1, wherein said communication opening is aligned with or substantially aligned with an axis of the passage.

3. The dispensing gun according to claim 1, wherein the dividing member is formed as a flat plate disposed perpendicularly to an axis of the passage.

4. The dispensing gun according to claim 1, wherein the dividing member has a shape of a bottomed cylinder protruding toward the cutting means.

5. The dispensing gun according to claim 1, wherein the dividing member has a protruding central part aligned with the axis of the passage and provided with the communication opening therein.

6. The dispensing gun according to claim 5, wherein the protruding central part has a shape of a circular cone protruding toward the cutting means.

7. The dispensing gun according to claim 5, wherein the protruding central part has a shape of a bottomed cylinder protruding toward the cutting means.

8. The dispensing gun according to claim 1, wherein the dividing member has a shape of a circular cone protruding toward the closing member.

9. The dispensing gun according to claim 1, wherein the dividing member has a shape of a bottomed cylinder protruding toward the closing member.

10. The dispensing gun according to claim 1, wherein the communication opening of the dividing member is formed as a single hole aligned with the axis of the passage.

11. The dispensing gun according to claim 1, wherein the communication opening of the dividing member is formed as a group of holes distributed around the axis of the passage.

12. The dispensing gun according to claim 1, wherein the communication opening is formed as a grid aligned with the axis of the passage.

13. The dispensing gun according to claim 1, wherein the communication opening formed in the dividing member has a sectional area between 10% and 80% of a sectional area of the passage.

14. The dispensing gun according to claim 1, wherein the discharge openings of the closing member are disposed radially outside a circumference of the communication openings when viewed in a discharging direction.

15. The dispensing gun according to claim 14, wherein the discharge openings of the closing member are disposed at a same distance from an axis of the passage when viewed in a discharging direction.

16. The dispensing gun according to claim 1, wherein the cutting means is a cutting blade having cutting part including cutting edge to form the outlet, said cutting part defines a space on a front side of the cutting edge with respect to a discharging direction, around which the circumference of the outlet lies when the viscous liquid material is pushed out of the outlet.

17. The dispensing gun according to claim 16, wherein the cutting means has a cutting part formed as a boomerang-shape including a sharp point for piercing the front end part of the pouch, cutting edges extending from the sharp point to form the outlet, said cutting part defines a triangular space on a front side of the cutting edges with respect to the discharging direction, around which the circumference of the outlet lies when the viscous liquid material is pushed out of the outlet.
